(19) United States
(12) Patent Application Publication
(10) Pub. No.: US 2020/0123847 A1
(43) Pub. Date: Apr. 23, 2020

(54) Universal Mount for Window Covering

(71) Applicant: SHADES UNLIMITED, INC. DBA REDI SHADE, INC., Cotati, CA (US)

(72) Inventors: Richard Konopelski, Cotadi, CA (US); Robert Wilk, Cotati, CA (US); Kyle O'Conner, Cotati, CA (US)

(73) Assignee: SHADES UNLIMITED, INC. DBA REDI SHADE, INC., Cotati, CA (US)

(21) Appl. No.: 16/525,459

(22) Filed: Jul. 29, 2019

Related U.S. Application Data
(60) Provisional application No. 62/784,292, filed on Dec. 21, 2018.
(60) Provisional application No. 62/711,447, filed on Jul. 27, 2018.

(51) Int. Cl. E06B 9/42

(52) U.S. Cl. CPC E06B 9/42

(57) ABSTRACT

The invention comprises the use of two symmetric plastic mounting pieces for installation and use of a roller shade. The plastic mounting pieces incorporate low profile designs and a detent and symmetric channels for accommodating nearly all commercially available roller shades that utilize one or two prongs. The invention further comprises a method of installing the mounting pieces with out the use of a screw driver or level with the use of a mounting template that illustrates for an installer how to size a roller shade and how to orient the plastic mounting pieces in an efficient time saving manner. The installation uses adhesive type tabs similar or identical to 3M's Command® adhesive tabs.

### CROSS-REFERENCE TO RELATED APPLICATIONS

This application is a non-provisional application of U.S. provisional application No. 62/784,292 filed Dec. 21, 2018 and U.S. provisional application No. 62/711,447, filed Jul. 27, 2018, all of which are incorporated herein by reference.

### FIELD OF THE INVENTION

The present invention relates to methods and apparatus for installing window coverings and more particularly improves many of the individual steps of the procedure including the elimination of a level, screw driver, and; it also incorporates a novel removal component.

### BACKGROUND OF THE INVENTION

Redi Shade is currently the world leader in paper, cellular, and pleated paper window treatment. Mounting of window treatments typically requires installation by a handyman.

### SUMMARY OF THE INVENTION

The present invention provides improved methods and systems for installing roller shades, paper shades, and other window coverings with a universal mount device and system. The universal mount device is symmetric along the vertical axis. Additionally, a template is provided for positioning the universal mount device to aid in installation and circumvent the requirement of using a level to provide an even appearance and function for the roller shade.

### BRIEF DESCRIPTION OF THE FIGURES

FIG. 1 illustrates roller window shade installed between two universal window mounts for window coverings.

FIG. 2 illustrates a universal window mount for window coverings from the wall mount side (exterior).

FIG. 3 illustrates a perspective view of a universal window mount for window coverings with a roller shade installed.

FIG. 4 illustrates a perspective view of a universal window mount for window coverings.

FIG. 5 illustrates a straight on view of a universal window mount for window coverings.

FIG. 6 illustrates a side view of a universal window mount for window coverings.

FIG. 7 illustrates a top side view of a universal window mount for window coverings.

FIG. 8 illustrates a bottom side view of a universal window mount for window coverings.

FIG. 9 illustrates a back side view of a universal window mount for window coverings.

FIGS. 10-12 illustrate a double sided adhesive mounting strip 20 with a pull tab from a front, side, and oblique perspective.

FIGS. 13-14 illustrates a preferred embodiment of a universal window mount for window coverings with measurements on a front side and left side.

FIGS. 15-16 illustrates a preferred embodiment of a mounting template with and without measurements of relative sizes for multiple sized roller shades.

### DETAILED DESCRIPTION OF THE INVENTION

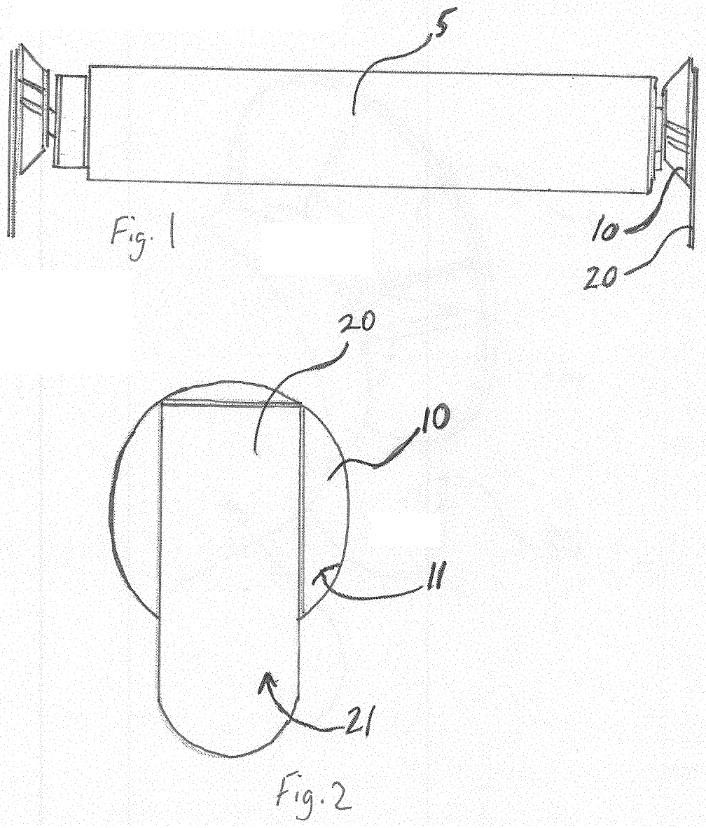

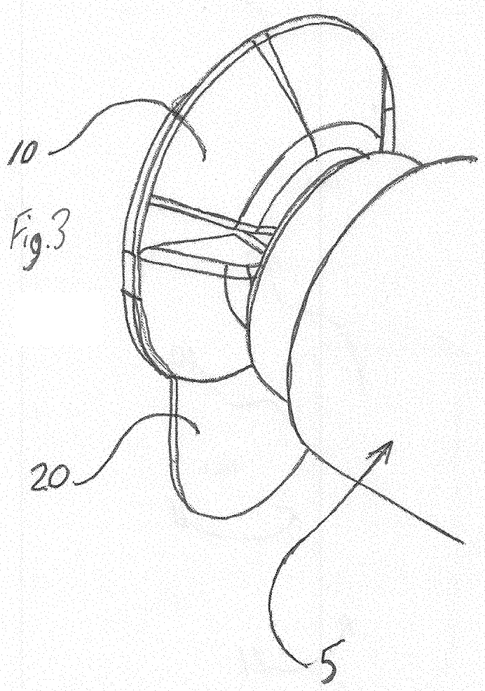

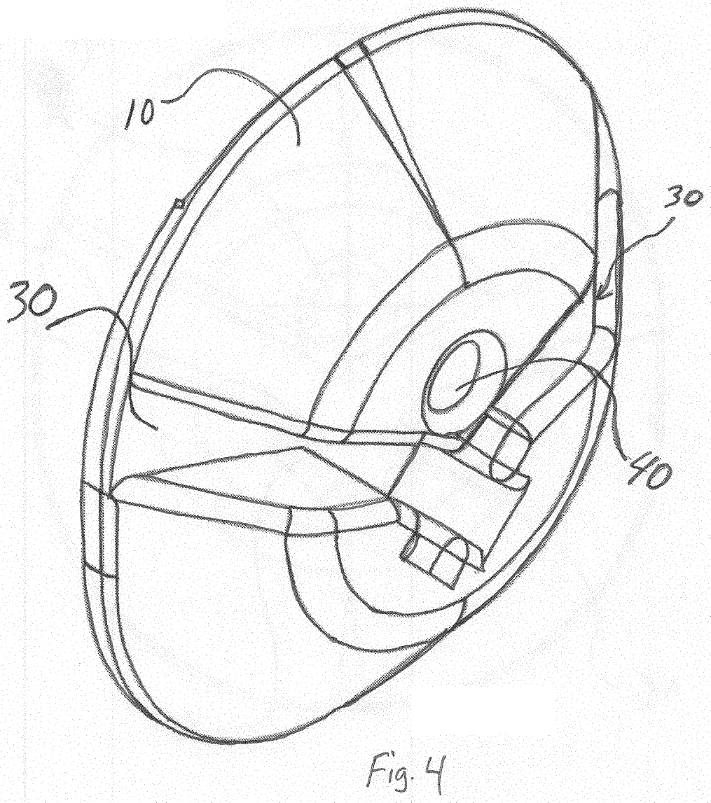

Referring first to FIG. 1 a preferred embodiment of the present invention measuring approximately two inches square. Window mount for window coverings 10 are mounted on the inside surface of a wall typically covered in drywall and paint adjacent to a window. Roller shades 5 are commercially available and come in numerous dimensions to accommodate windows with generally small narrow gaps from the wall to the attachment to limit the amount of light that may enter a room. The present embodiment window mount for window coverings 10 is capable of firm attachment to a wall and accommodating most commercially available roller shades 5 because the roller shades have prongs for engaging channel(s) 30 and detents 40 in 10. Window mount for window coverings 10 can be constructed of many materials with polymers being preferred over wood, metal, or other naturally occurring substances. The FIG. 2 shows a back side 11 of a Window mount for window coverings 10 with a double sided adhesive mounting strip 20 attached. Adhesive 21 can be applied to a surface portion 23 of the adhesive mounting strip 20 or applied to lesser area of the surface portion 23 on the adhesive mounting strip 20 to accommodate larger or smaller roller shade mass. The double sided adhesive mounting strip 20 has a pull tab portion 25 that remains attached and exposed such that the pull tab portion 25 can be pulled by a user after installation and the adhesive 21 will release from the wall or an attachment surface so that there is no damage to the wall, paint, or attachment surface. In a preferred embodiment the adhesive 21 is capable of withstanding the weight of a window covering or roller shade 25 plus an additional three to twenty-five pounds (3-25 lbs) of force to maintain the window covering or roller shade 25 firmly in place. FIG. 3 shows a window covering or roller shade 5 installed into a window mount for window coverings 10.

Window shades come in many designs with a generally common element of having two prongs for mounting or used for stabilizing a shade bar. The art of window shade mounting is well known commonly having one or two metal prongs to slip into metal brackets. The present invention is capable of receiving all types of prong design window coverings or roller shades 5 including single and double prong design window attachment designs. Especially with roller type window coverings, a prong is designed to rotate about a central axis and the central axis is in the same as the center of the roller shade 5 to make opening and retraction smooth while rotating. Specifically, the prong(s) are designed to engage channel 30 and detent 40 in the window mount for window coverings 10.

FIG. 4 shows a window mount for window coverings 10 in a perspective view. The inventive aspect is that there is a detent 40 and there are two channels 30 that lead to over hangs 35 to secure the prongs of a roller shade 5. The detent 40 can be cylindrical or conical in shape. Alternatively, the detent 40 could have a chamfer on the outer perimeter to aid in installation of roller shade 5 prong. The channel 30 can additionally have over hangs 35 that can capture or hold a window covering in place with a frictional fit or gravity fit. For the sake of clarity, over hangs 35 are at a central portion of the window mount for window covering 10 and at the terminus of a channels 30. The over hang 35 is generally the same width and dimensions of the rest of the channel 30, but the angle between the channel 30 and over hang 35 may not be parallel, i.e. up to 100 degrees different between the channel 30 and the over hang 35. In a preferred embodiment a channel 30 is 0.1 inch to 0.4 inch wide to accept a window shade prong. The over hangs 35 can have similar widths as the channels 30, or may be broader or narrower, so long as they are wide enough to receive prongs from a window covering or roller shade 5, generally 0.5 mm-5 mm width or thickness of a prong. The length of the over hang 35 can be 0 to 8 mm in length. The depth of the detent 40 and channel 30 is determined by the strength of the material and engineering considerations, generally, in a preferred embodiment the thickness of the window mount for window coverings 10 is less than two centimeters thick, the channel 30 would necessarily be thinner than the universal window mount for window coverings 10 window. FIGS. 13 & 14 show examples of actual dimensions in inches. The channel 30 would generally not traverse the whole thickness of universal Window mount for window coverings 10, in said cases. Design exceptions with strengthened or reinforced channels with extra material could be used and the channels 30 could be all the way through the universal window mount for window coverings 10. The detent 40 is generally in or adjacent a center portion of the window mount for window coverings 10 and is designed to receive a window shade prong. The detent 40 can have the same thickness as the universal mount for window coverings 10. The detent 40 in a preferred embodiment is comprised of the channels and overhangs and the thickness is determined by the overall thickness of the universal window mount for window coverings 10. The detent 40 is generally circular in shape for optionally receiving a prong from a window covering or roller shade 5 and the thickness limitations are similar to that of the channels 30 because the detent 40 will generally be made by stamping or blow molding for a single piece of polymer material. The engineering limitations are generally, that the material must be strong enough to withstand the expected forces applied to a window covering or roller shade 5 upon installation and use, approximately 2-25 pounds of force.

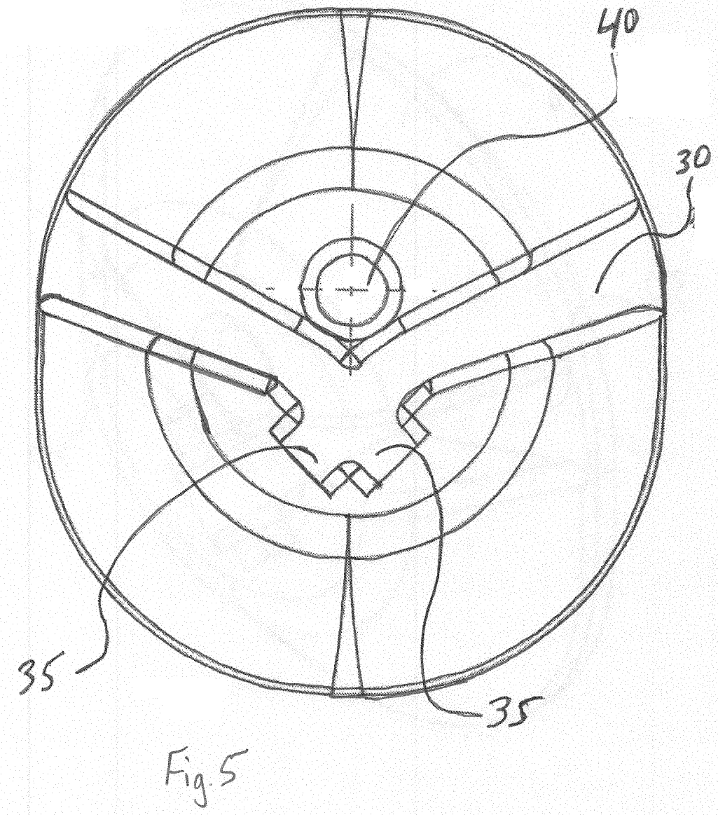

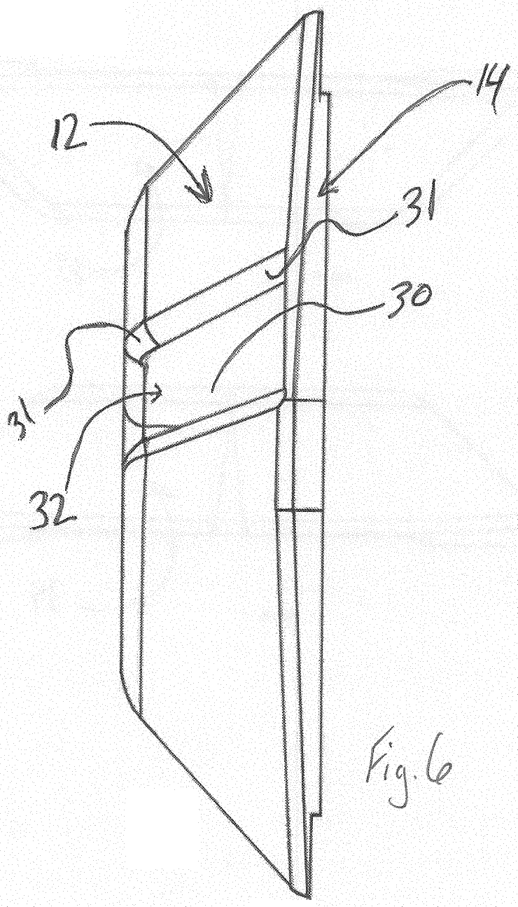

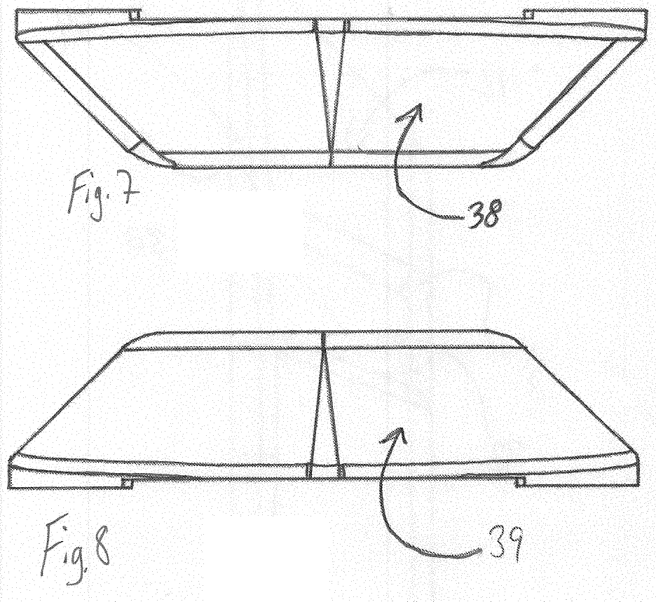

FIGS. 5-8 show the universal mount for window coverings from different angles. It can be seen that the channels 30 can have a taper wherein the width increase towards the outer dimensions and narrows towards the center, near the detent 40. FIG. 6 shows a front side 12 and back side 14 of the window mount for window coverings 10. The channel 30 may have a uniform depth but due to the design dimensions of the channel, installation may require force to overcome a raised portion of the channel 30 so that a window shade prong would slide over a hill portion in the channel 30 on the prongs travel path to the over hang 35. FIG. 6 it is further apparent that the channel 30 dimensions have a depth can be defined by side portions 31 as discussed above. The hill portion 32 in the channel 30 could serve as an additional frictional element to stabilize or secure the roller shade 5 to the window mount for window coverings 10 in an operable position. The hill portion 32 can change the channel 30 depth relative height while maintaining the channel depth approximately 0 mm-8 mm relative to the back side 11 of window mount for window coverings 10. FIG. 7 shows a view from the top of the window mount for window coverings 10. While FIG. 8 shows a bottom view of window mount for window coverings 10.

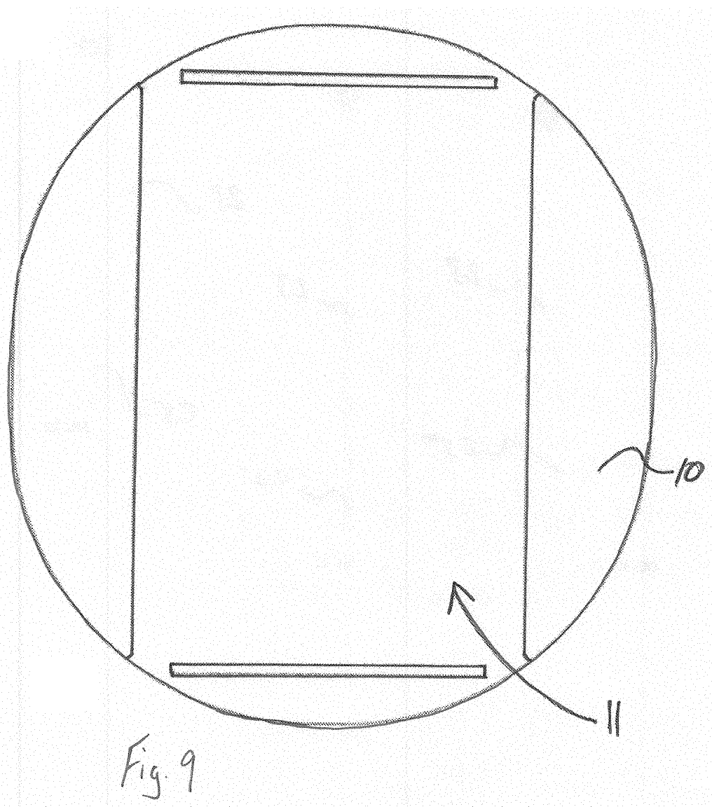

FIG. 9 shows the back side 11 where adhesive 21 attaches to window mount for window coverings 10.

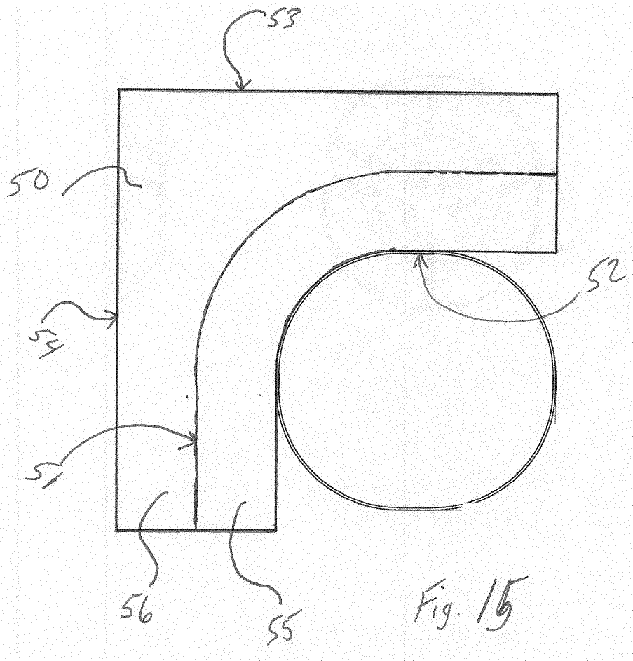

FIGS. 13-14 show dimensions of the universal mount for window coverings, with the adjacent detent 40 having a preferred diameter of 3.56 millimeters. The thickness of the entire window mount for window coverings 10 is about 8 millimeters in this embodiment.

The over hangs 35 generally do not extend more than 5 millimeters past the overlap of the channels 30, where the channels 30 meet.

### No Tool Bracket Installation

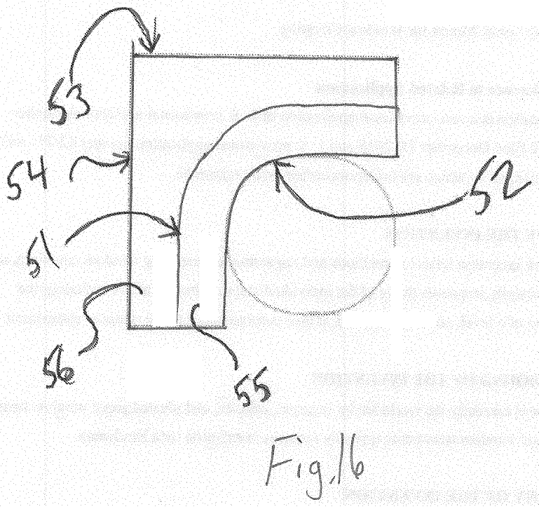

The present invention provides for a simplified installation method utilizing a mounting template 50 disclosed in FIGS. 15 & 16. FIG. 15 shows a mounting template 50 for use with both a large and small roller shade 5 with dimensions to clarify the relative dimensions for installation. FIG. 16 shows a mounting template 50 for use with both a large and small roller shade 5 without dimensions. The mounting template 50 has a perforated line 51 drawn on the template 50 that delineates large roll 55 and small roll 56 portions. The mounting template has a right angle between the top 53 and side 54 and a curved portion 52 for accommodating the roller shade 5. The top 53 of the mounting template 50 is placed against the wall so that the top 53 is touching the top of window casing and side 54 is parallel to the window, this position eliminates the need for a level. The mounting template 50 may be comprised of a thin piece of paper or plastic like material. For example, a user could determine that they will be installing a “large roll” that requires more clearance for the roller shade 5 to operate properly. In such a case the user leaves the “large roll” portion 55 intact. If the user determines that a “small roll” will be installed, the user can remove large roll portion 55 along the perforated line 51 so that only the small roll portion 56 remains in place against the wall. Optionally, once the mounting template 50 sizing and placement are complete, the user places the mounting template 50 and may make a pencil mark for placing the window covering mount for windows 10. Alternatively, the user can place the mounting template 50 up to the window casing and wall and directly place the window mount for window coverings 10 with the adhesive 21 exposed on the adhesive tab portion 23 and apply pressure to make the window mount for window coverings 10 adhere to the wall. Specifically, the adhesive tabs 20 are prepared by the user pulling a liner off of the adhesive portion 23 to expose adhesive to attach the window mount for window coverings 10 to the wall. The adhesive mounting strip 20 can be similar to a 3M Command® tab and the user can install the mounting strip 20 with an arrow pointing in the down direction. The mounting strip 20 is held in place by the user and the user applies pressure to confirm good adhesion between the window mount for window coverings 10 and the wall. For the sake of clarity, the user places the window mount for window coverings 10 along the template curved portion 52, this creates a perfect alignment for installation of a roller shade 5. The user will place the first window mount for window coverings 10 with the mounting template 50 on one side and then repeat the process, but the user only needs to flip the mounting template 50 for installation on the opposite side of the window. With the window mount for window coverings 10 applied to the wall, the user then installs a roller shade 5 by inserting a round pin (prong) into the detent 40 of the window mount for window coverings 10 and slides a flat pin (second prong) by rotating it into a channel 30 until it locks in place, generally to the over hang portion 35. The symmetric nature of the window 10 channels 30 allow the user to install the roller shade 5 with one template that does not require the use of a level. Further, the user does not need to determine the left or right side orientation because the channel 30 is symmetric and accessible from both sides of the window mount for window coverings 10.

The angle of the channel 30 is generally at forty-five degrees from the top or side of window mount for window coverings 10, but can vary to about twenty degrees from top or side, i.e. a range of 20-70 degrees and the channels are generally symmetric, though it is not an absolute requirement. The fact that the channels 30 are symmetric helps with the installation because a left side and right side designation is not required. A handyman can tell you that installation of a chiral mount is often mounted and remounted several times to ensure a proper orientation. This design reduces the number of possible orientations for installation.

Examples of window mount styles are shown here:

Example of a window mount prong capable of mounting and rotating:

In a preferred embodiment of a window mount for window coverings 10, the entire piece is made from a single molded piece of plastic. In a preferred embodiment of a window mount for window coverings 10, the height and width are approximately one to two inches square. The edges of the window mount for window coverings 10 may be rounded or smoothed to reduce the likelihood of snagging or catching a window covering or roller shade 5 upon installation.

In a preferred embodiment the overall thickness of the window mount for window coverings 10 is less than one or one half of an inch.

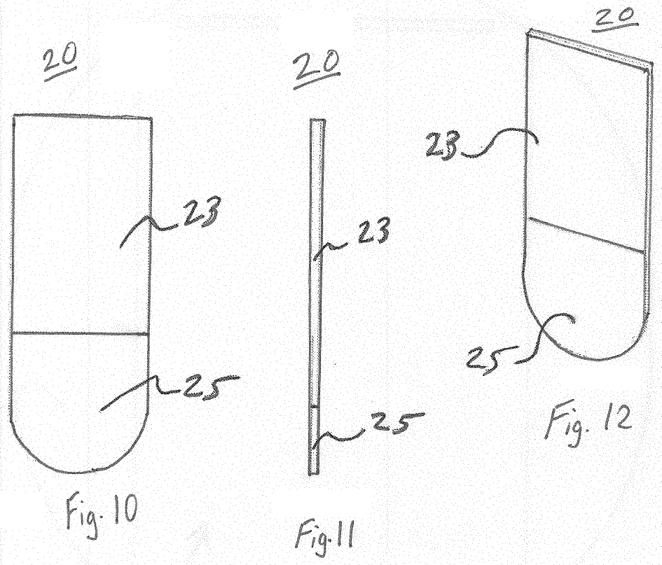

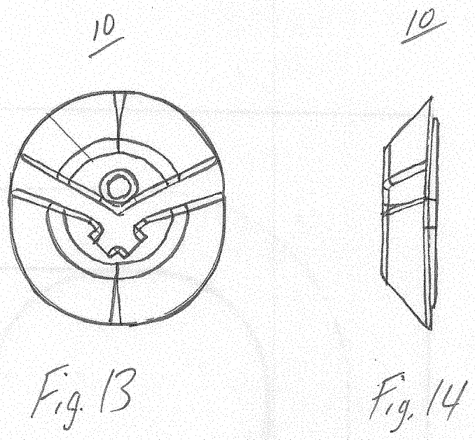

FIG. 9 shows a back side of the window mount has a flat surface for receiving a double sided adhesive mounting strip 20. FIGS. 10-12 show a double sided adhesive mounting strip 20, 3M currently manufactures various sizes and strengths of double sided adhesives that also have a pull tab portion 25 that can be used to remove the adhesive tab 20 and anything attached to the adhesive tab 20, typically to remove window mount for window coverings 10 from a wall or door for home use. Tab portion 23 has adhesive 21 on both sides of the adhesive tab 20. Portion 25 of the adhesive tab 20 is the thumb and finger grab location to remove the tab after installation, if required.

The universal window covering mount can be adapted for receiving window coverings with attachment ends or means similar to fluorescent light bulbs with two prongs shown here:

It will thus be appreciated that a new and novel method of window treatment installation has been disclosed, as well as a new and novel window treatment and components thereof. Among the advantages offered by one or more of implementations of the invention are a controlled installation of a window covering without the use of a level or permanent attachment means. Having fully disclosed a variety of implementations of the present invention, it will be appreciated by those skilled in the art that numerous alternatives and equivalents exist which do not materially alter the invention described herein. Therefore, the invention is not intended to be limited by the foregoing description, but instead only by the appended claims.

What is claimed is:

1. A window mount for window coverings comprising a single molded piece of plastic with two symmetric channels and a detent where in the symmetric channel further have an over hang that has an angle of zero to seventy degrees from the channel and wherein the over hang is between one and five millimeters deep and the detent and over hang are capable of receiving a prong from a roller shade.

2. A universal window mount for window coverings formed of a single piece of plastic and having a width between 1-2 inches and a height of 1-2 inches and a thickness of 0.5-1.0 inches and where in two channels are formed from the sides to a center portion near a detent and wherein the channel has an angled portion to form an over hang for each channel and wherein the detent and over hang can receive two prongs from a roller shade.

3. A method of installing a window covering comprising: a mounting template that can be positioned adjacent a top of a window casing and a side of a window casing and wherein a user may select a roller shade size of small or large wherein the user leaves the mounting template with a large roll portion intact for installation of a large roller shade or alternatively, the user tears the large roll portion off of the mounting template along a perforated line for installation of a small roller shade; and the user places a first window mount for window coverings by removing a liner from an adhesive portion integrated on the window mount for window coverings; and the user applies pressure to the window mount for window coverings to make it adhere to a window casing without the use of a level, then the user flips the mounting template to the other side of the top window casing and attaches a second window mount for window coverings, said first and second window mount for window coverings are level and the user may install a roller shade by inserting roller shade prongs into a detent in the first and second window mount for window coverings and then rotating the roller shade until a second prong engages a channel on each of the first and second window mount for window coverings and the user stops rotating once the roller shade prongs engage an over hang in each of said first and second window mount for window coverings.
